(19) United States
(12) Patent Application Publication
(10) Pub. No.: US 2014/0045034 A1
(43) Pub. Date: Feb. 13, 2014

(54) NONAQUEOUS ELECTROLYTE SECONDARY BATTERY

(71) Applicant: SANYO ELECTRIC CO., LTD., Osaka (JP)

(72) Inventors: Tomo Kondo, Kasai-shi (JP); Masahiro Iyori, Kasai-shi (JP); Keisuke Minami, Kanzaki-gun (JP); Toyoki Fujihara, Kanzaki-gun (JP); Toshiyuki Nohma, Kakogawa-shi (JP)

(73) Assignee: SANYO ELECTRIC CO., LTD., Osaka (JP)

(21) Appl. No.: 13/962,057

(22) Filed: Aug. 8, 2013

(30) Foreign Application Priority Data
Aug. 9, 2012 (JP) 2012-177491

(51) Int. Cl. H01M 10/0585

(52) U.S. Cl. CPC H01M 10/0585
USPC 429/153

(57) ABSTRACT

A nonaqueous electrolyte secondary battery includes: a stacked electrode assembly formed by stacking a plurality of layers of a positive electrode plate and a plurality of layers of a negative electrode plate with a separator interposed therebetween; a nonaqueous electrolyte formed by dissolving LiPF₆ into a mixed solvent; and an aluminum laminated outer body that stores the stacked electrode assembly and into which the electrolyte is poured. The nonaqueous electrolyte contains LiBOB and LiPF₂O₂. Each of the positive electrode plate and the negative electrode plate has an area of 100 cm² or larger. The stacked electrode assembly has a thickness in the stacking direction of 10 mm or smaller.

### TECHNICAL FIELD

The present invention relates to a nonaqueous electrolyte secondary battery.

### BACKGROUND ART

In recent years, exhaust controls on carbon dioxide gas and other substances have become stricter as actions to safeguard the environment are increased. In the motor vehicle industry, therefore, the development of electric vehicles (EVs) and hybrid electric vehicles (HEVs) has become accelerated as a substitute for vehicles using fossil fuel such as gasoline, diesel oil, and natural gas. Nickel-hydrogen secondary batteries and lithium-ion secondary batteries have been used as batteries for EVs and HEVs. In recent years, nonaqueous electrolyte secondary batteries such as lithium-ion secondary batteries have been used more often because of their light weight and high capacity. For such a nonaqueous electrolyte secondary battery, an outer body of aluminum-laminated film is proposed because it enables an easy increase in size and decrease of the cost of material.

It is required for the batteries for EVs and HEVs to respond to the improvement of basic performance for automobiles, namely, driving performance such as accelerating performance and hill-climbing performance, as well as environmental friendliness. Furthermore, it is required to prevent degradation of the driving performance even in severe environments (usage in very cold areas and very hot areas).

It has been proposed to add difluorophosphate to a nonaqueous electrolyte in order to improve low-temperature discharge characteristics of the nonaqueous electrolyte secondary battery (refer to JP-A-2007-141830).

However, batteries for EVs and HEVs are used in various kinds of environments, which requires further improvement.

### SUMMARY

An advantage of some aspects of the invention is to provide a nonaqueous electrolyte secondary battery including: a stacked electrode assembly formed by stacking a plurality of layers of a positive electrode plate and a plurality of layers of a negative electrode plate with a separator interposed therebetween; and an outer body storing the stacked electrode assembly and a nonaqueous electrolyte. The outer body is formed using a laminated film. The nonaqueous electrolyte contains LiBOB (lithium bis(oxalato)borate) and/or a boron-containing substance derived from the LiBOB. Each of the positive electrode plate and the negative electrode plate has an area of 100 cm² or larger. The stacked electrode assembly has a thickness in the stacking direction of 10 mm or smaller.

The invention provides a nonaqueous electrolyte secondary battery suitable for EVs and HEVs.

### BRIEF DESCRIPTION OF THE DRAWINGS

The invention will be described with reference to the accompanying drawings, wherein like numbers reference like elements.

FIG. 1 is a perspective view of a nonaqueous electrolyte secondary battery in accordance with an embodiment.

FIG. 2 is a sectional arrow view of a modification of a stacked electrode assembly.

FIG. 3 is a sectional arrow view of a modification of a stacked electrode assembly.

FIG. 4 is a sectional arrow view of a modification of a stacked electrode assembly.

FIG. 5 is a sectional arrow view of a modification of a stacked electrode assembly.

FIG. 6 is a sectional arrow view of a modification of a stacked electrode assembly.

FIG. 7 is a sectional arrow view of a modification of a stacked electrode assembly.

FIG. 8 is a sectional arrow view of a modification of a stacked electrode assembly.

FIG. 9 is a sectional arrow view of a modification of a stacked electrode assembly.

FIG. 10 is a perspective view of a laminated outer body in a separated body structure.

FIG. 11 is a perspective view of a laminated outer body in an integrated body structure.

### DESCRIPTION OF EXEMPLARY EMBODIMENTS

An advantage of some aspects of the invention is to provide a nonaqueous electrolyte secondary battery including: a stacked electrode assembly formed by stacking a plurality of layers of a positive electrode plate and a plurality of layers of a negative electrode plate with a separator interposed therebetween; and an outer body storing the stacked electrode assembly and a nonaqueous electrolyte. The outer body is formed using a laminated film. The nonaqueous electrolyte contains LiBOB and/or a boron-containing substance derived from LiBOB. Each of the positive electrode plate and the negative electrode plate has an area of 100 cm² or larger. The stacked electrode assembly has a thickness in the stacking direction of 10 mm or smaller.

Adding LiBOB to a nonaqueous electrolyte leads to a covering of a decomposition product of the LiBOB formed onto a surface of the negative electrode active material. Such a covering at normal temperatures serves as a protective covering of the negative electrode active material and thus is useful. However, such a covering at high temperatures (about 200° C. or more) reacts with the electrolyte and generates heat, consequently causing a problem in that the temperature of the battery further increases. The temperature of a battery therefore increases easily when LiBOB is added to a battery including a flattened wound electrode assembly (an electrode assembly formed by winding a positive electrode plate and a negative electrode plate into a spiral shape with a separator interposed therebetween; and applying pressure to the resultant substance) with poor heat-releasing characteristics. As a result of diligent study, the inventors of the invention have found that a battery including a stacked electrode assembly is superior in heat-releasing characteristics to a battery including a flattened wound electrode assembly; however, a battery is required not only to include a stacked electrode assembly but also to fulfill conditions as follows.

Specifically, it is required that each of the positive electrode plate and the negative electrode plate has an area of 100 cm² or larger; the stacked electrode assembly has a thickness in the stacking direction of 10 mm or smaller; and the outer body is formed using a laminated film. The surface area cannot be sufficiently ensured if the positive electrode plate and the negative electrode plate each have an area smaller than 100 cm², resulting in a decrease in the heat-releasing characteristics. A stacked electrode assembly having a thickness in the stacking direction over 10 mm increases the distance between the outer body and a member, such as the negative electrode plate, that is disposed at a center part in the stacking direction, resulting in a decrease in the heat-releasing characteristics in the electrode plate. An outer body of a laminated film with flexibility (likely to be deformed) increases the contact area between the outer body and the stacked electrode assembly, leading to improvement in the heat-releasing characteristics. The laminated film is a film formed by stacking and bonding (laminating) a resin film onto both sides of a metal layer. Aluminum, nickel, and other materials are preferably used for the metal layer.

The following describes a reason why the nonaqueous electrolyte may contain not only LiBOB but also a boron-containing substance derived from the LiBOB. The nonaqueous electrolyte contains LiBOB immediately after fabricating the battery (before a first charge and discharge); however, after the first charge and discharge, the LiBOB can be decomposed to form a covering on a surface of the negative electrode active material. Thus, the nonaqueous electrolyte does not always contain LiBOB.

Preferably, the positive electrode plate and the separator are attached to each other, and the negative electrode plate and the separator are attached to each other. Such a structure improves heat conductivity between each of the electrode plates and the separator, which improves the heat-releasing characteristics of the battery (the heat-releasing characteristics inside the battery). Preferably, the battery has a large capacity of 10 Ah or more. A battery having a large capacity generally includes a positive electrode plate and negative electrode plate each having a large area.

Preferably, the nonaqueous electrolyte contains LiPF₂O₂ (lithium difluorophosphate) for a reason described below. Preferably, the battery is sealed under vacuum or reduced pressure. In such a battery sealed under reduced pressure, the stacked electrode assembly and the outer body are in closer contact with each other, and the heat conductivity therebetween is improved. This further improves the heat-releasing characteristics.

A nonaqueous electrolyte secondary battery of the invention includes: a stacked electrode assembly formed by stacking a plurality of layers of a positive electrode plate and a plurality of layers of a negative electrode plate with a separator interposed therebetween; and an outer body storing the stacked electrode assembly and a nonaqueous electrolyte. The outer body is formed using a laminated film. The nonaqueous electrolyte contains LiPF₂O₂. Each of the positive electrode plates and the negative electrode plates has an area of 100 cm² or larger. The stacked electrode assembly has a thickness in the stacking direction of 10 mm or smaller.

The heat-releasing characteristics of a battery is improved when the battery fulfills the following conditions: each of the positive electrode plate and the negative electrode plate has an area of 100 cm² or larger; the stacked electrode assembly has an thickness in the stacking direction of 10 mm or smaller; and the outer body is formed using a laminated film. However, a battery having excellent heat-releasing characteristics means a small difference between the battery temperature and the external temperature. The temperature of the nonaqueous electrolyte secondary battery of the invention is therefore likely to decrease in a cold area. Thus, the nonaqueous electrolyte secondary battery of the invention including a stacked electrode assembly requires improvement in low-temperature characteristics. The improvement in the low-temperature characteristics is attained by adding LiPF₂O₂ to the nonaqueous electrolyte.

Preferably, the positive electrode plate and the separator are attached to each other, and the negative electrode plate and the separator are attached to each other. Preferably, the battery has a capacity of 10 Ah or more.

Preferably, the nonaqueous electrolyte contains LiBOB (lithium bis(oxalato)borate) and/or a boron-containing substance derived from LiBOB. Preferably, the battery is sealed under vacuum or reduced pressure.

The following describes the invention in further detail on the basis of a specific embodiment. However, the invention is not limited in any way to the following embodiment, and can be implemented by modifying as appropriate as long as its summary is not changed.

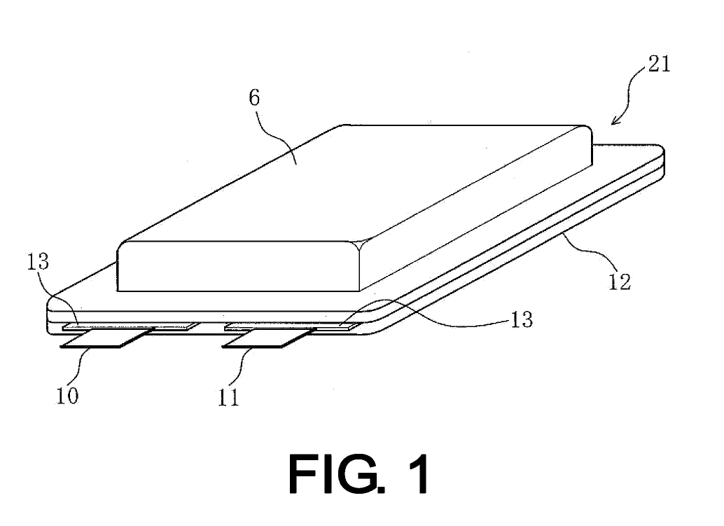

As illustrated in FIG. 1, a nonaqueous electrolyte secondary battery 21 includes an aluminum laminated outer body 6 having a sealed part 12 in which edges are heat-sealed. The aluminum laminated outer body 6 forms a storing space, and a stacked electrode assembly is disposed therein. This stacked electrode assembly has a structure in which a plurality of layers of a positive electrode plate and a plurality of layers of a negative electrode plate are stacked with a separator interposed therebetween. In addition, the stacked electrode assembly is impregnated with a nonaqueous electrolyte. The positive electrode plate is electrically connected to a positive electrode terminal 10 with a positive electrode collector tab. The negative electrode plate is electrically connected to a negative electrode terminal 11 with a negative electrode collector tab. The numeral 11 in FIG. 1 indicates an insulating film.

A positive electrode plate as above can be fabricated as follows.

A positive electrode active material represented by LiNi_{0.35}Co_{0.35}Mn_{0.30}O₂ and having a layer structure, carbon black as a conductive agent, and PVDF (polyvinylidene fluoride) as a binding agent are kneaded in a solution of N-methyl-2-pyrrolidone to prepare a positive electrode mixture slurry. Although the ratio of the positive electrode active material, the carbon black, and the PVDF in the positive electrode mixture slurry is not limited, the ratio may be 88:9:3 by mass. Next, the positive electrode mixture slurry is applied to both sides of a rectangular positive electrode collector of an aluminum foil. The resultant object is dried and then extended by applying pressure using a roller. A positive electrode plate 1 is thus fabricated in which a positive electrode mixture layer is formed on both sides of the positive electrode collector.

A negative electrode plate as above can be fabricated as follows.

CMC (carboxymethyl cellulose) as a thickening agent is dissolved into water, and graphite powder as a negative electrode active material is added to the solution and mixed by stirring. Subsequently, SBR (styrene-butadiene rubber) as a binding agent is mixed to the solution, thereby preparing a negative electrode mixture slurry. Although the ratio of the graphite, the CMC, and the SBR in the negative electrode mixture slurry is not limited, the ratio may be 98:1:1 by mass. Next, the negative electrode mixture slurry is applied to both sides of a rectangular negative electrode collector of a copper foil. The resultant object is dried and then extended by applying pressure using a roller, thereby fabricating a negative electrode plate 2 in which a negative electrode mixture layer is formed onto both sides of the negative electrode collector.

A nonaqueous electrolyte as above can be prepared as follows.

For example, lithium salt as a solute is dissolved into a mixed solvent containing ethylene carbonate (EC) and methylethyl carbonate (MEC). Although the ratio of the EC and the MEC is not limited in this case, they may be mixed at a volume ratio of 3:7 at a temperature of 25° C., for example. Although the kind of the lithium salt as a solute or the proportion thereof is not limited in this case, LiPF₆ may be dissolved at 1 mol/L, for example. Furthermore, lithium salt as additives, LiPF₂O₂ and/or LiBOB (lithium bis(oxalato)borate) are/is added to the nonaqueous electrolyte. The additive amount of the LiPF₂O₂ may be 0.05 mol/L, and that of the LiBOB may be 0.1 mol/L. However, the additive amounts of the LiPF₂O₂ and the LiBOB are not limited thereto. The additive amount of the LiPF₂O₂ is only required to be from 0.01 to 2 mol/L, and more preferably from 0.01 to 0.1 mol/L. The additive amount of the LiBOB is only required be to from 0.01 to 2 mol/L, and more preferably from 0.01 to 0.2 mol/L. The ranges as above are preferable because the additive cannot provide its addition effect sufficiently when the additive amount thereof is too small; and the viscosity of the nonaqueous electrolyte increases when the additive amount is too large and this prevents smooth charge-discharge reactions. Vinylene carbonate (VC) may be added to the nonaqueous electrolyte in order to form a covering on a surface of the negative electrode active material and thus prevent degradation of the negative electrode active material. For example, the vinylene carbonate may be added so that its proportion to the nonaqueous electrolyte is 0.1 to 5% by mass.

A nonaqueous electrolyte secondary battery can be fabricated as follows using the positive electrode plate, the negative electrode plate, and the nonaqueous electrolyte.

A plurality of layers of the positive electrode plate above and a plurality of layers of the negative electrode plate above are stacked with a separator of polyethylene interposed therebetween so as to face each other, thereby fabricating a stacked electrode assembly. The positive electrode collector tab extending from the positive electrode plate is fixed (electrically connected) to the positive electrode terminal 10. The negative electrode collector tab extending from the negative electrode plate is fixed (electrically connected) to the negative electrode terminal 11. The stacked electrode assembly is disposed inside the aluminum laminated outer body together with the nonaqueous electrolyte. The aluminum laminated outer body is then heat-sealed, thereby fabricating the nonaqueous electrolyte secondary battery (the battery capacity: 16 Ah).

Any material may be used for the positive electrode collector without limitation as long as the material does not cause chemical change inside the battery and has a high conductivity. For example, the following materials may be used: stainless steel; aluminum; nickel; titanium; or plastic carbon. In addition, aluminum or stainless steel with surface processing of carbon, nickel, titanium, or silver may be used. The positive electrode collector may have microasperity on its surface in order to increase the sticking force with the positive electrode active material. Furthermore, the positive electrode collector may have various forms and, in other words, may be formed with a film, layer, foil, net, porous substance, foam substance, and non-woven fabric substance, for example.

The positive electrode active material should be formed using a material such as the following: a layer compound such as lithium cobalt oxide (LiCoO₂) and lithium nickel oxide (LiNiO₂), or a compound containing one or more kinds of transition metals instead of the cobalt or nickel in the layer compound above; a spinel lithium manganese oxide represented by a chemical formula Li₁₊ₓMn₂₋ₓO₄ (where x=0 to 0.33), or another lithium-manganese oxide (for example, LiMnO₃, LiMn₂O₃, or LiMnO₂); lithium copper oxide (LiCuO₂); vanadium oxide (for example, LiV₃O₈, V₂O₅, or Cu₂V₂O₇); a Ni-site lithium nickel oxide represented by a chemical formula LiNi₁₋ₓMₓO₂ (where M=Co, Mn, Al, Cu, Fe, Mg, B or Ga, and x=0.01 to 0.3); a lithium-manganese composite oxide represented by a chemical formula LiMn₂₋ₓMxO₂ (where M=Co, Ni, Fe, Cr, Zn, or Ta, and x=0.01 to 0.1) or Li₂Mn₃MO₈ (where M=Fe, Co, Ni, Cu, or Zn); a compound represented by a chemical formula LiMn₂O₄ in which part of Li is replaced with an alkaline-earth metal ion; a disulfide; and Fe₂(MoO₄)₃. However, a material for the positive electrode active material is not limited thereto.

Furthermore, a mixture of two or more kinds of the materials as above may be used for the positive electrode active material. For example, a mixture of a lithium-nickel-cobalt-manganese composite oxide and a spinel lithium manganese oxide may be used. A lithium-transition metal compound as above preferably contains nickel and/or manganese.

Any material may be used for the conductive agent of the positive electrode plate without limitation as long as the material does not cause chemical change inside the battery and has a high conductivity. For example, the following material may be used: natural graphite; artificial graphite; carbon black; acetylene black; ketjen black; channel black; furnace black; lamp black; thermal black; carbon fiber; metal fiber; fluorocarbon powder; aluminum powder; nickel powder; zinc oxide; potassium titanium oxide; titanium oxide; and a polyphenylene derivative.

The following material may be used for the binding agent of the positive electrode plate: polyvinylidene fluoride; polyvinyl alcohol; carboxymethyl cellulose; starch; hydroxypropylcellulose; regenerated cellulose; polyvinylpyrrolidone; tetrafluoroethylene; polyethylene; polypropylene; ethylene-propylene-diene terpolymer (EPDM); sulfonated EPDM; styrene-butadiene rubber; fluorine-containing rubber; and various copolymers thereof.

If necessary, a filler may be used that prevents the positive electrode plate from expanding. Any material may be used for the filler without limitation as long as the material does not cause chemical change inside the battery and is manufactured using a fiber material. For example, the following material may be used: an olefin polymer (polyethylene polypropylene, and the like); and a fiber material (glass fiber, carbon fiber, and the like).

Furthermore, the positive electrode active material may contain at least one selected from the group consisting of boron (B), fluorine (F), magnesium (Mg), aluminum (Al), titanium (Ti), chromium (Cr), vanadium (V), iron (Fe), copper (Cu), zinc (Zn), niobium (Nb), molybdenum (Mo), zirconium (Zr), tin (Sn), tungsten (W), sodium (Na), and potassium (K). The positive electrode active material (for example, a lithium-transition metal compound) containing such an element can lead to an effect of further increasing thermal stability.

Any material may be used for the negative electrode collector without limitation as long as the material does not cause chemical change inside the battery and has a high conductivity. For example, the following materials may be used: copper; stainless steel; nickel; titanium; or plastic carbon. The following may also be used: copper or stainless steel with surface processing of carbon, nickel, titanium, or silver; and an aluminum-cadmium alloy. The negative electrode collector may have microasperity on its surface in order to increase the sticking force with the negative electrode active material. Furthermore, the negative electrode collector may have various forms and, in other words, may be formed with a film, layer, foil, net, porous substance, foam substance, and non-woven fabric substance, for example.

Carbon may be used for the negative electrode active material, such as natural graphite, artificial graphite, mesophase-pitch carbon fiber (MCF), mesocarbon microbeads (MCMB), coke, hard carbon, fullerene, and carbon nanotube, for example. A metal composite oxide also may be used for the negative electrode active material, such as LiₓFe₂O₃ (0≦x≦1), LiₓWO₂ (0≦x≦1), and SnₓMe₁₋ₓMe′_{y}Oₓ (Me=Mn, Fe, Pb, or Ge; Me′=Al, B, P, Si, an element in group 1, 2, or 3 of the periodic table, or a halogen element; 0<x≦1, 1≦y≦3, 1≦z≦8). Furthermore, the following material may be used: a lithium metal; a lithium alloy; a silicon alloy or silicon-based alloy; a tin-based alloy; a metal oxide, such as SnO, SnO₂, SiOₓ (0<x<2), PbO, PbO₂, Pb₂O₃, Pb₃O₄, Sb₂O₃, Sb₂O₄, Sb₂O₅, GeO, GeO₂, Bi₂O₃, Bi₂O₄, or Bi₂O₅; a conductive polymer, such as polyacetylene; or an Li—Co—Ni based material. In addition, the surface of the negative electrode active material may be covered with amorphous carbon.

The negative electrode plate may be fabricated using a conductive agent, a binding agent, and a filler used for the positive electrode plate.

A solvent of the nonaqueous electrolyte is not limited in any way. The following shows examples of such a solvent: an aprotic organic solvent, such as N-methyl-2-pyrrolidone, propylene carbonate, ethylene carbonate, butylene carbonate, dimethyl carbonate, fluoroethylene carbonate, diethyl carbonate, methylethyl carbonate, γ-butyrolactone, 1,2-dimethoxyethane, tetrahydrofuran, 2-methyltetrahydrofuran, dimethylsulfoxide, 1,3-dioxolan, formamide, dimethylformamide, dioxolan, acetonitrile, nitromethane, methyl formate, methyl acetate, phosphate triester, trimethoxymethane, dioxolanes, sulfolane, methylsulfolane, 1,3-dimethyl-2-imidazolidinone, propylene carbonate derivative, tetrahydrofuran derivative, ether, methyl propionate, and ethyl propanoate. In particular, it is preferable to use a mixed solvent of a cyclic carbonate such as ethylene carbonate, and a chain carbonate such as dimethyl carbonate.

The following shows examples of a lithium salt as a solute: LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, (C₂F₅SO₂)₂NLi, (CF₃SO₂)₃CLi, lithium chloroborane, lower-aliphatic carboxylic lithium, and lithium tetraphenyl borate.

To improve the charge/discharge characteristics and flame resistance, the nonaqueous electrolyte may contain a material such as the following: pyridine; triethyl phosphite; triethanolamine; cyclic ether; ethylenediamine; n-glyme; hexaphosphoric triamide; nitrobenzene derivative; sulfur; quinoneimine dye; N-substituted oxazolidinone; N,N-substituted imidazolidine; ethylene glycol dialkyl ether; ammonium salt; pyrrole; 2-methoxyethanol; and aluminum trichloride. To add incombustibility, the nonaqueous electrolyte may further contain a halogen-containing organic solvent such as carbon tetrachloride and trifluoroethylene. Furthermore, to improve preservation stability at high temperatures, carbon dioxide gas may be dissolved into the nonaqueous electrolyte.

The structure of the stacked electrode assembly is not limited to the structure above. The stacked electrode assembly may have a structure as follows.

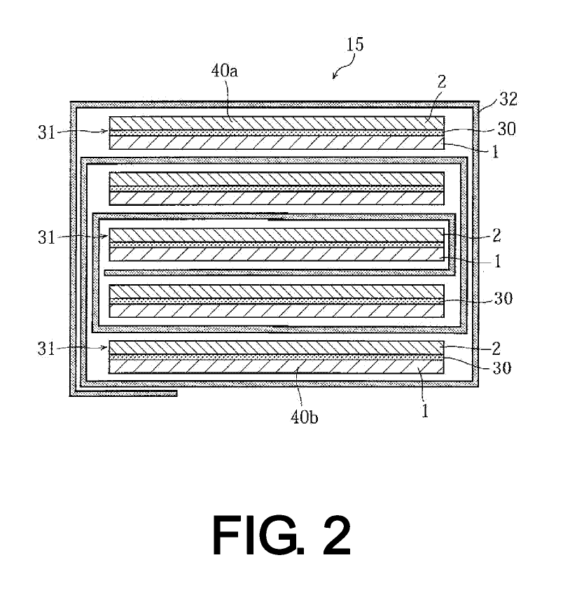

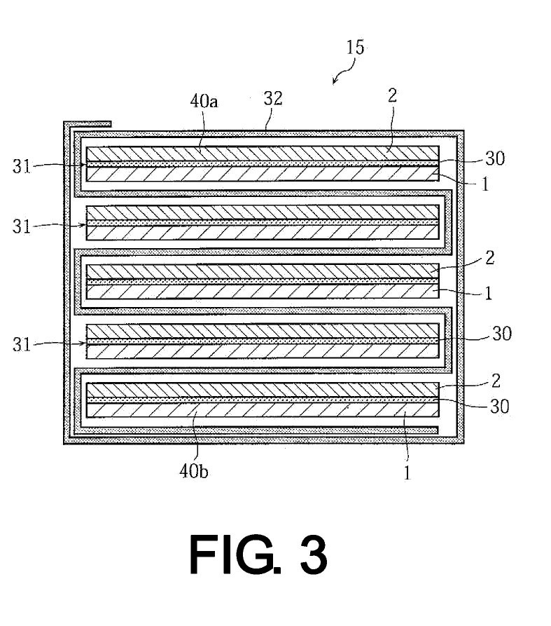

For example, as illustrated in FIG. 2, a stacked electrode assembly includes a unit cell 31 having a rectangular layer of a positive electrode plate 1 and a rectangular layer of a negative electrode plate 2 with a rectangular layer of a first separator 30 interposed therebetween (hereinafter, a unit cell having a positive electrode plate on one side and a negative electrode plate on the other side as above will be referred to as a type-I cell I; in this definition, a type-I cell includes a cell having a layer of the positive electrode plate 1, a layer of the first separator 30, a layer of the negative electrode plate 2, a layer of the first separator 30, a layer of the positive electrode plate 1, a layer of the first separator 30, and a layer of the negative electrode plate 2 in this order). The stacked electrode assembly has a structure (spiral structure) in which a plurality of type-I cells 31 are stacked; and a belt-shaped second separator 32 is disposed between the stacked type-I cells so as to surround each of the type-I cells. In a case as above of using a plurality of type-I cells 31, the structure of the belt-shaped second separator 32 is not limited to the spiral structure. As illustrated in FIG. 3, the second separator 32 may have a structure in which it is folded back at an end of each of the type-I cells 31.

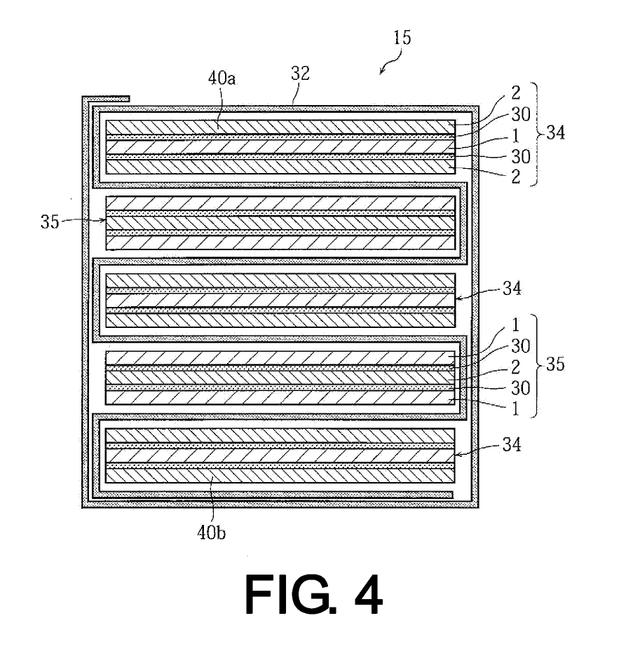

FIGS. 2 and 3 show a space between the second separator 32 and the layers of the positive electrode plate 1 and the negative electrode plate 2 in the type-I cell 31 to facilitate visualization. In practice, however, the second separator 32 is closely attached or bonded to the layers of the positive electrode plate 1 and the negative electrode plate 2. This applies to embodiments below (embodiments illustrated in FIGS. 4 to 8). Furthermore, in a case of using the type-I cell 31 in FIGS. 2 and 3, two electrode plates 40a and 40b that are disposed at the outermost sides in a stacked electrode assembly 15 have different polarities.

The stacked electrode assembly 15 may have a structure as illustrated in FIG. 4. The stacked electrode assembly 15 in this case includes a cell different in structure from the cell in the stacked electrode assembly 15 as illustrated in FIG. 3. In FIG. 4, a cell includes electrode plates having the same polarity on both ends. Specifically, the stacked electrode assembly 15 has a structure in which a cell 34 (hereinafter referred to as a type-IIc cell) and a cell 35 (hereinafter referred to as a type-IIa cell) are alternately arranged. The cell 34 includes a layer of the negative electrode plate 2, a layer of the first separator 30, a layer of the positive electrode plate 1, a layer of the first separator 30, and a layer of the negative electrode plate 2 stacked in this order. The cell 35 includes a layer of the positive electrode plate 1, a layer of the first separator 30, a layer of the negative electrode plate 2, a layer of the first separator 30, and a layer of the positive electrode plate 1 stacked in this order.

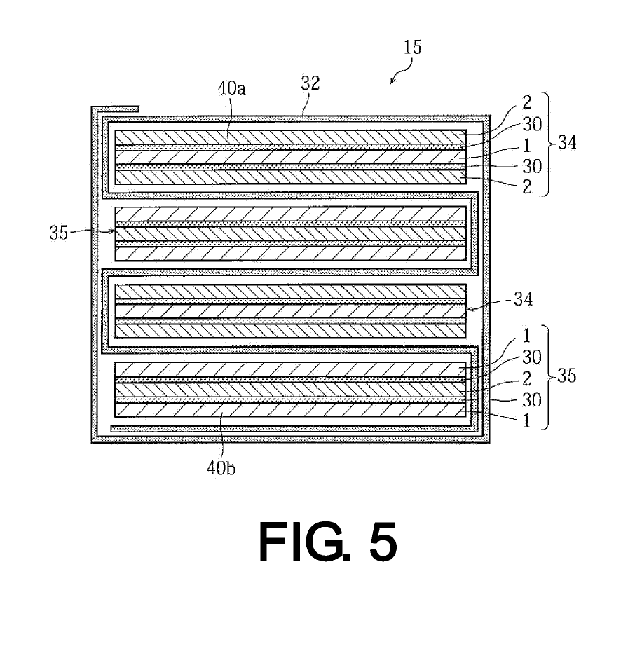

In a case of using an odd number in total of the type-IIc cell 34 and the type-IIa cell 35 as illustrated in FIG. 4, the two electrode plates 40a and 40b that are disposed at the outermost sides have the same polarity. In a case of using an even number in total of the type-IIc cell 34 and the type-IIa cell 35 as illustrated in FIG. 5, the two electrode plates 40a and 40b that are disposed at the outermost sides have different polarities.

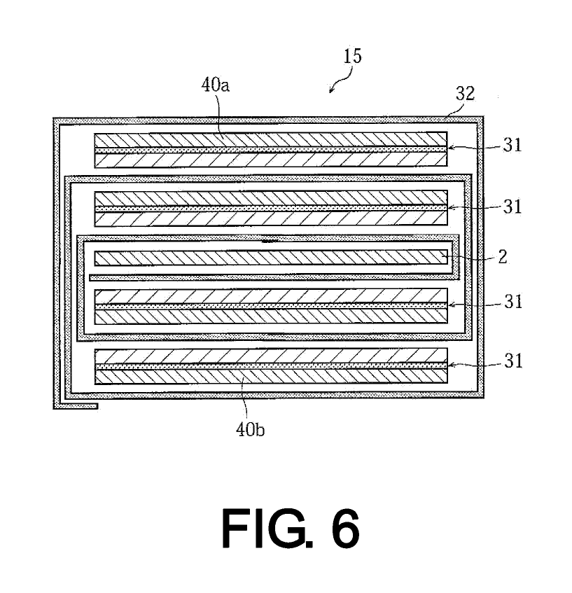

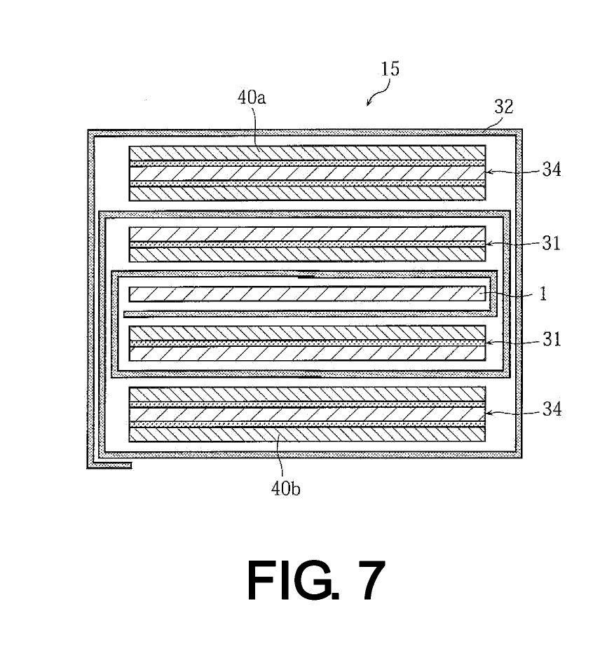

The stacked electrode assembly 15 may have a structure in which the type-I cell 31 is stacked onto both surfaces of a layer of the negative electrode plate 2, as illustrated in FIG. 6. Such a structure allows the two electrode plates 40a and 40b that are disposed at the outermost sides in the stacked electrode assembly 15 to have the same polarity even in a case of using the type-I cell 31. The stacked electrode assembly 15 may have a structure in which the type-I cell 31 and the type-IIc cell 34 are stacked onto both surfaces of a layer of the positive electrode plate 1, as illustrated in FIG. 7. Such a structure also allows the two electrode plates 40a and 40b that are disposed at the outermost sides in the stacked electrode assembly 15 to have the same polarity.

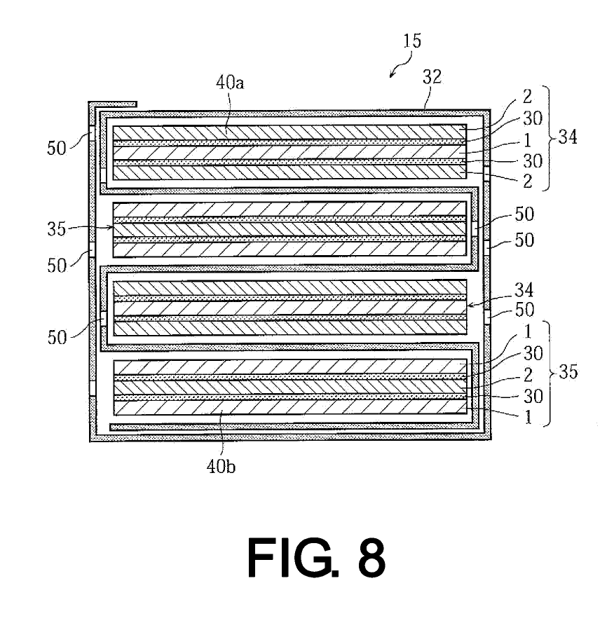

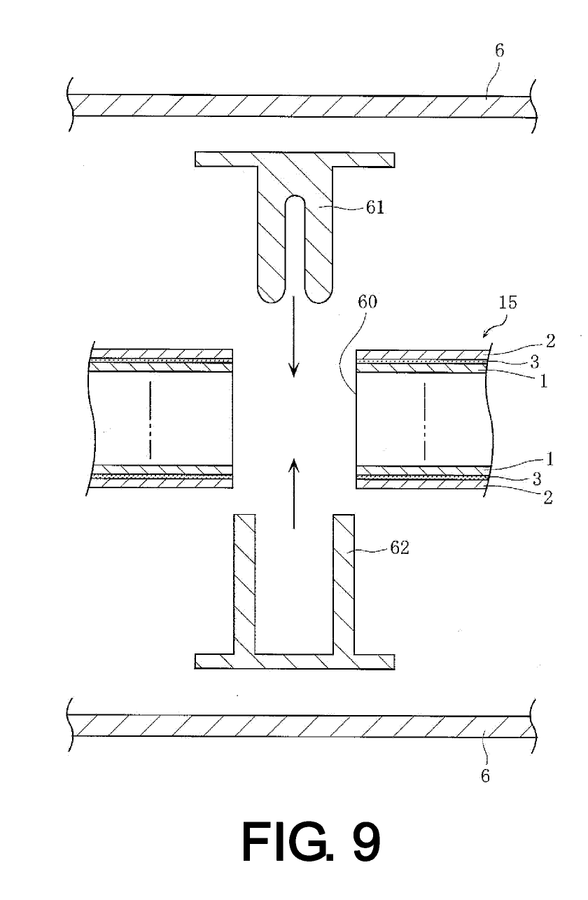

Furthermore, as illustrated in FIG. 8, part of the second separator 32 arranged at the lateral side of the stacked electrode assembly 15 may have a through-hole 50 formed in order to facilitate electrolyte moving in and out. As illustrated in FIG. 9, a through-hole 60 may be formed in the stacked electrode assembly 15; and a concave member 62 and a convex member 61 are fitted in the through-hole 60, thereby sandwiching and holding the stacked electrode assembly 15.

In a case of fabricating the stacked electrode assembly as illustrated in FIGS. 2 to 8, a porous covering layer may be formed at least one surface of either of the first separator 30 or the second separator 32, the positive electrode plate 1, and the negative electrode plate 2. Such a covering layer may serve as a bonding layer to bond the first separator 30 or the second separator 32 and the positive electrode plate 1 or the negative electrode plate 2, which are in close contact with the separators 30 and 32. A porous covering layer may be formed on at least one surface of either of a separator 3, the positive electrode plate 1, and the negative electrode plate 2 shown in FIG. 9. Such a covering layer may serve as a bonding layer. The porous covering layer should contain inorganic particles and a binder.

The inorganic particles above may be inorganic particles having a permittivity of 5 or larger such as the following: BaTiO₃; Pb(Zr, Ti)O₃ (PZT); Pb₁₋ₓLaₓZr_{1-y}Ti_{y}O₃ (PLZT); PB(Mg₃Nb_{2/3})O₃—PbTiO₃ (PMN-PT); hafnia (HfO₂); SrTiO₃; SnO₂; CeO₂; MgO, NiO, CaO; ZnO; ZrO₂; Y₂O₃; Al₂O₃; TiO₂; SiC; or a mixture of these materials. The inorganic particles also may be inorganic particles capable of transferring lithium (inorganic particles that contain lithium element, does not store lithium, and is capable of transferring lithium) such as the following: a glass of (LiAlTiP)ₓO_{y} (0<x<4, 0<y<13) such as lithium phosphate (Li₃PO₄), lithium titanium phosphate (LiₓTi_{y}(PO₄)₃, 0<x<2, 0<y<3), lithium aluminum titanium phosphate (LixAlyTiz(PO₄)₃, 0<x<2, 0<y<1, 0<z<3), and 14Li₂O—9Al₂O₃—38TiO₂—39P₂O₅; lithium germanium thiophosphate (LiₓGe_{y}P_{z}S_{w}, 0<x<4, 0<y<1, 0<z<1, 0<w<5) such as lithium lanthanum titanate (LiₓLa_{y}TiO₃, 0<x<2, 0<y<3) and Li_{3.25}Ge_{0.25}P_{0.75}S₄; lithium nitride (LiₓN_{y}, 0<x<4, 0 21 y<2) such as Li₃N; a SiS₂-based glass (LiₓSi_{y}S_{z}, 0<x<3, 0<y<2, 0<z<4) such as Li₃PO₄—Li₂S—SiS₂; a P₂S₅-based glass (LiₓP_{y}S_{z}, 0<x<3, 0<y<3, 0<z<7) such as LiI—Li₂S—P₂S₅; or a mixture of these materials.

The following shows examples of the binder above: polyvinylidene fluoride-hexafluoropropylene; polyvinylidene fluoride-trichloroethylene; polymethylmethacrylate; polyacrylonitrile; polyvinylpyrrolidone; polyvinyl acetate; ethylene-vinyl acetate copolymer; polyethylene oxide; cellulose acetate; cellulose acetate butyrate; cellulose acetate propionate; cyanoethylated pullulan; cyanoethylated polyvinyl alcohol; cyanoethylated cellulose; cyanoethylated sucrose; pullulan; and carboxymethylcellulose.

The separator above may be formed using a polypropylene separator, a polyethylene separator, and a polypropylene-polyethylene multilayered separator, for example.

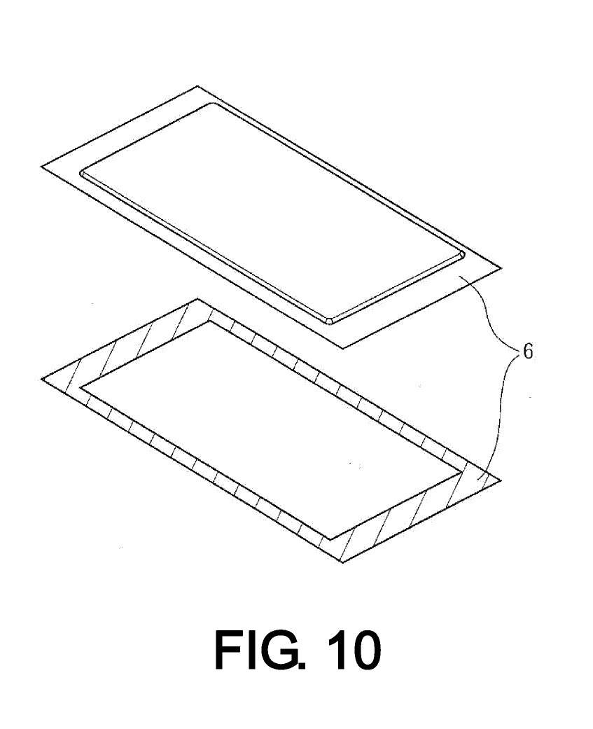

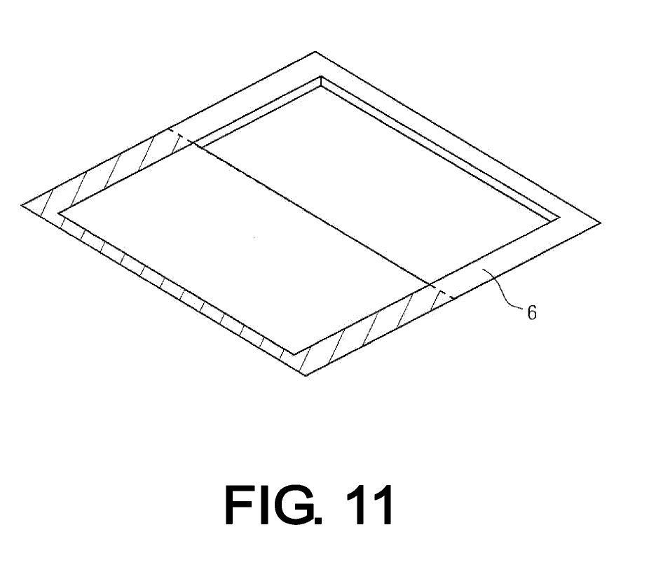

The aluminum laminated outer body 6 preferably has a separated body structure as illustrated in FIG. 10 rather than an integrated body structure as illustrated in FIG. 11. The integrated body structure allows only three sides (refer to the hatched area in FIG. 11) of the aluminum laminated outer body 6 to be sealed, while the separated body structure allows four sides (refer to the hatched area in FIG. 10) of the aluminum laminated outer body 6 to be sealed. The separated body structure thus leads to a larger surface area of the battery.

The invention can be used for a driving supply of EVs and HEVs requiring high outputs.

1. A nonaqueous electrolyte secondary battery comprising:
a stacked electrode assembly formed by stacking a plurality of layers of a positive electrode plate and a plurality of layers of a negative electrode plate with a separator interposed therebetween; and
an outer body storing the stacked electrode assembly and a nonaqueous electrolyte,
the outer body being formed using a laminated film,
the nonaqueous electrolyte containing LiBOB (lithium bis(oxalato)borate) and/or a boron-containing substance derived from the LiBOB,
each of the positive electrode plate and the negative electrode plate having an area of 100 cm² or larger, and
the stacked electrode assembly having a thickness in the stacking direction of 10 mm or smaller.

2. The nonaqueous electrolyte secondary battery according to claim 1, wherein
the positive electrode plate and the separator are attached to each other, and the negative electrode plate and the separator are attached to each other.

3. The nonaqueous electrolyte secondary battery according to claim 1, wherein
the battery has a capacity of 10 Ah or more.

4. The nonaqueous electrolyte secondary battery according to claim 1, wherein
the nonaqueous electrolyte contains LiPF₂O₂ (lithium difluorophosphate).

5. The nonaqueous electrolyte secondary battery according to claim 1, wherein
the battery is sealed under reduced pressure.

6. A nonaqueous electrolyte secondary battery comprising:
a stacked electrode assembly formed by stacking a plurality of layers of a positive electrode plate and a plurality of layers of a negative electrode plate with a separator interposed therebetween; and
an outer body storing the stacked electrode assembly and a nonaqueous electrolyte,
the outer body being formed using a laminated film,
the nonaqueous electrolyte contains LiBOB (lithium bis(oxalato)borate) at the time of making the nonaqueous electrolyte secondary battery,
each of the positive electrode plate and the negative electrode plate having an area of 100 cm² or larger, and
the stacked electrode assembly having a thickness in the stacking direction of 10 mm or smaller.

7. A nonaqueous electrolyte secondary battery according to claim 6, wherein the nonaqueous electrolyte contains LiPF₂O₂ (lithium difluorophosphate) at the time of making the nonaqueous electrolyte secondary battery.
